(19) United States
(12) Patent Application Publication
(10) Pub. No.: US 2012/0134420 A1
(43) Pub. Date: May 31, 2012

(54) APPARATUS AND METHOD FOR TRANSMITTING VIDEO DATA IN VIDEO DEVICE

(75) Inventors: Sung-Jae Cho, Seoul (KR); Yu-Jin Lee, Seoul (KR); Hyun-Soo Kim, Hwaseong-si (KR)

(73) Assignee: SAMSUNG ELECTRONICS CO., LTD., Suwon-si (KR)

(21) Appl. No.: 13/302,998

(22) Filed: Nov. 22, 2011

(30) Foreign Application Priority Data
Nov. 30, 2010 (KR) 10-2010-0120200

(51) Int. Cl. H04N 7/26

(52) U.S. Cl. 375/240.24; 375/E07.076

(57) ABSTRACT

An apparatus and method transmit video data in a video device. The apparatus includes a controller and an encoding unit. The controller is configured to control the encoding unit, divide a video data input screen into a plurality of regions, and transmit encoded data on the divided videos to a remote system. The encoding unit is configured to encode the divided videos into video data.

### CROSS-REFERENCE TO RELATED APPLICATION(S) AND CLAIM OF PRIORITY

The present application is related to and claims priority under 35 U.S.C. §119(a) to a Korean patent application filed in the Korean Intellectual Property Office on Nov. 30, 2010, and assigned Serial No. 10-2010-0120200, the contents of which are herein incorporated by reference.

### TECHNICAL FIELD

The present disclosure relates to an image transmission system. More particularly, the present disclosure relates to an apparatus and method for transmitting a high quality of video data to a remote system in a video device.

### BACKGROUND

In recent years, portable terminals, a necessity to modern people, have become widely used. Service providers and system manufacturers are competitively developing products (and services) for differentiation from other enterprises.

For example, the portable terminals evolve into multimedia equipment for phone books, games, short messages, electronic mail (e-mail) messages, morning wakeup calls, MPEG-1 Audio Layer 3 (MP3) players, schedule management functions, digital cameras, and wireless Internet services and provide a variety of services.

The development of the above digital camera function allows the portable terminal to provide a video call function such as a face-to-face call.

FIG. 1 is a diagram illustrating a general video data transmission process of a portable terminal.

Referring to FIG. 1, the portable terminal 100 encodes the whole video data 110 input through a camera at a maximum resolution supported by the portable terminal and then, transmits the encoded video data 110 to a receiving-side portable terminal 102.

The receiving-side portable terminal 102 decodes the received encoded data and outputs the whole decoded picture 112.

In a situation where the portable terminal transmits video data compressing the whole data input through an Internet Protocol (IP) based service at a low resolution (e.g., a Quarter Common Intermediate Format (QCIF)), a receive apparatus cannot receive high quality data.

To solve the above problem, an apparatus and method for transmitting high quality video data in a portable terminal are needed.

### SUMMARY

To address the above-discussed deficiencies of the prior art, it is a primary aspect of the present disclosure is to provide an apparatus and method for transmitting high quality video data in a video device.

Another aspect of the present disclosure is to provide an apparatus and method for partially compressing and providing input data in a video device.

A further aspect of the present disclosure is to provide an apparatus and method for granting numbering or image coordinates of partially compressed video data in a video device.

Yet another aspect of the present disclosure is to provide an apparatus and method of a remote system for decoding data received from a video device and outputting the decoded data to a corresponding region.

The above aspects are achieved by providing an apparatus and method for transmitting video data in a video device.

In accordance with an aspect of the present disclosure, an apparatus for transmitting data in a video device is provided. The apparatus includes a controller and an encoding unit. The controller is configured to control the encoding unit, divide a video data input screen into a plurality of regions, and transmit encoded data on the divided videos to a remote system. The encoding unit is configured to encode the divided videos into video data.

In accordance with another aspect of the present disclosure, a method for transmitting data in a video device is provided. The method includes dividing a video data input screen into a plurality of regions, encoding the divided videos into video data, and transmitting the encoded video data to a remote system.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other objects, features and advantages of the present disclosure will become more apparent from the following detailed description when taken in conjunction with the accompanying drawings in which:

FIG. 1 is a diagram illustrating a general video data transmission process of a portable terminal;

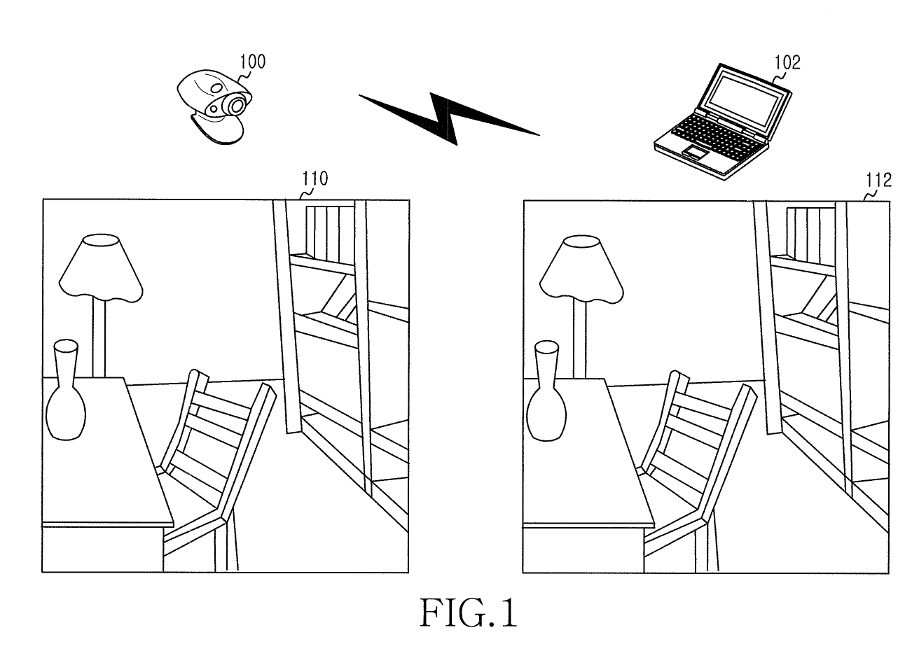

FIG. 2 is a block diagram illustrating a construction of a remote control system for transmitting high quality video data according to the present disclosure;

FIG. 3 is a flowchart illustrating a process of transmitting high quality video data in a video device according to the present disclosure;

FIG. 4 is a flowchart illustrating a process of providing data on a specific portion in a video device according to an embodiment of the present disclosure;

FIG. 5 is a flowchart illustrating a process of providing data on a specific portion in a video device according to another embodiment of the present disclosure;

FIG. 6 is a flowchart illustrating a process of receiving video data in a remote system according to an embodiment of the present disclosure;

FIGS. 7A and 7B are diagrams illustrating an operation process of a remote control system according to an embodiment of the present disclosure;

FIGS. 8A and 8B are diagrams illustrating a process of transmitting high quality video data of a specific region in a video device according to an embodiment of the present disclosure; and

FIGS. 9A and 9B are diagrams illustrating a process of magnifying and outputting data of a specific region in a remote system according to an embodiment of the present disclosure.

Throughout the drawings, like reference numerals will be understood to refer to like parts, components and structures.

### DETAILED DESCRIPTION

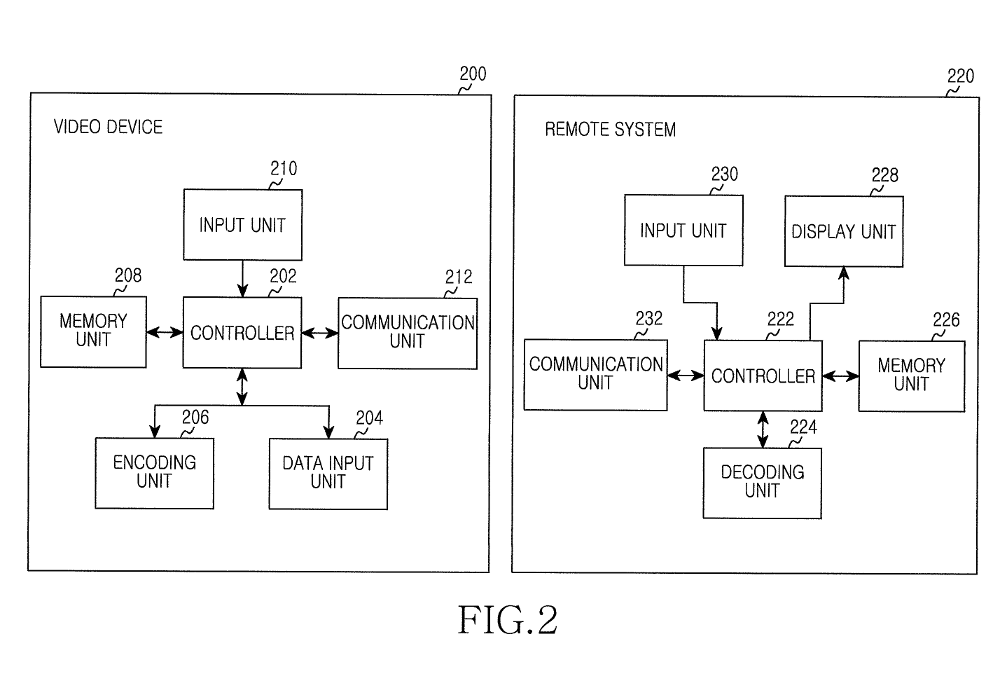

FIGS. 2 through 9B, discussed below, and the various embodiments used to describe the principles of the present disclosure in this patent document are by way of illustration only and should not be construed in any way to limit the scope of the disclosure.

Embodiments of the present disclosure provide an apparatus and method for transmitting high quality video data by partially compressing and providing input data in a video device that supports a lower quality resolution.

The video device, which is a video device supporting lower quality data, can be a mobile communication terminal supporting a camera function, a computer and television (TV) enabling video communication and the like. In the following description, a remote system can be a monitoring device for decoding and outputting data received from the video device.

FIG. 2 is a block diagram illustrating a construction of a remote control system for transmitting high quality video data according to the present disclosure.

Referring to FIG. 2, the remote control system can include a video device 200 and a remote system 220. The video device 200 can include a controller 202, a data input unit 204, an encoding unit 206, a memory unit 208, an input unit 210, and a communication unit 212.

The controller 202 of the video device 200 controls a general operation of the video device 200. For example, in a situation where the video device 200 is a mobile communication terminal, the controller 202 performs processing and control for voice call and data communication and, in a situation where the video device 200 is a TV, the controller 202 performs processing and control for output of received video data. In addition, the controller 202 controls a video call of the video device 200. According to an embodiment of the present disclosure, upon video call performance, the controller 202 processes to divide an input screen of video data into a plurality of regions and transmit data encoded by divided region to the remote system 220.

The controller 202 applies numbering or image coordinates (i.e., coordinates of X and Y axes of points forming the region) to the divided regions, distinguishes the divided regions, and matches a position of encoded data of the video device 200 and an output position of decoded data of the remote system 220.

Further, the controller 202 processes to determine a region in which data change is sensed among the divided regions, and provide, to the remote system, aiming at video data of the determined region.

Further, the controller 202 processes to encode data of a region requested from the remote system 220 and provide the encoded data to the remote system 220.

The data input unit 204, which is a module for receiving an input of video data, may be a camera module for a video call. The encoding unit 206 encodes input data of a divided region under the control of the controller 202. The encoding unit 206 can compress the divided region at a maximum resolution supported by the video device.

The memory unit 208 preferably includes, for example, a Read Only Memory (ROM), a Random Access Memory (RAM), a flash ROM, and such. The ROM stores a microcode of a program for processing and controlling the controller 202 and the encoding unit 206 and a variety of reference data.

The RAM, a working memory of the controller 202, stores temporary data generated in execution of a variety of programs. The flash ROM stores a diversity of updateable depository data such as a phone book, an outgoing message, an incoming message, and such.

The input unit 210 includes numeral key buttons ‘0’ to ‘9’, a menu button, a cancel button, an OK button, a talk button, an end button, an Internet button, navigation key (or direction key) buttons, and a plurality of function keys such as a character input key. The input unit 210 provides key input data corresponding to a key pressed by a user to the controller 202.

The communication unit 212 performs a function of transmitting, receiving or processing a wireless signal of data input or output through an antenna (not illustrated). For example, in a transmission mode, the communication unit 212 performs a function of processing original data through channel coding and spreading, converting the original data into a Radio Frequency (RF) signal, and transmitting the RF signal. In a reception mode, the communication unit 212 performs a function of converting a received RF signal into a baseband signal, processing the baseband signal through despreading and channel decoding, and restoring the signal to original data. According to the present disclosure, the communication unit 212 transmits encoded data and receives a data request for a specific region from the remote system 220.

A function of the encoding unit 206 can be implemented by the controller 202 of the video device 200. However, these are separately constructed and shown in the present disclosure as an exemplary construction for description convenience, and should not limit the scope of the present disclosure. It should be understood by those skilled in the art that various modifications of construction can be made within the scope of the present disclosure. For example, construction may be such that all of these are processed in the controller 202.

The remote system 220 can include a controller 222, a decoding unit 224, a memory unit 226, a display unit 228, an input unit 230, and a communication unit 232. The controller 222 controls a general operation of the remote system 220. For example, in a situation where the remote system 220 is a monitoring device, the controller 222 processes to decode data received from the video device 200 and output the decoded data. According to the present disclosure, the controller 222 divides an output screen into a plurality of regions, determines numbering or image coordinates of received data, and determines an output position of the data.

Further, the controller 222 magnifies and outputs data of a region selected by a user or sends a request for the data of the region selected by the user to the video device 200.

The decoding unit 224 decodes received data (i.e., data encoded in a divided region unit) under the control of the controller 222.

The display unit 228 displays state information generated during an operation of the remote system 220, characters, a large amount of moving pictures and still pictures and the like. According to the present disclosure, the display unit 228 decodes a divided video and outputs the decoded video to a corresponding region. The display unit 228 may be a color Liquid Crystal Display (LCD). In embodiments where the display unit 228 includes a touch input device and is applied to the remote system 220 of a touch input scheme, the display unit 228 can be used as an input device of the remote system 220.

The memory unit 226, input unit 230, and communication unit 232 have the same constructions as those of the video device 200 and thus, their detailed descriptions are omitted.

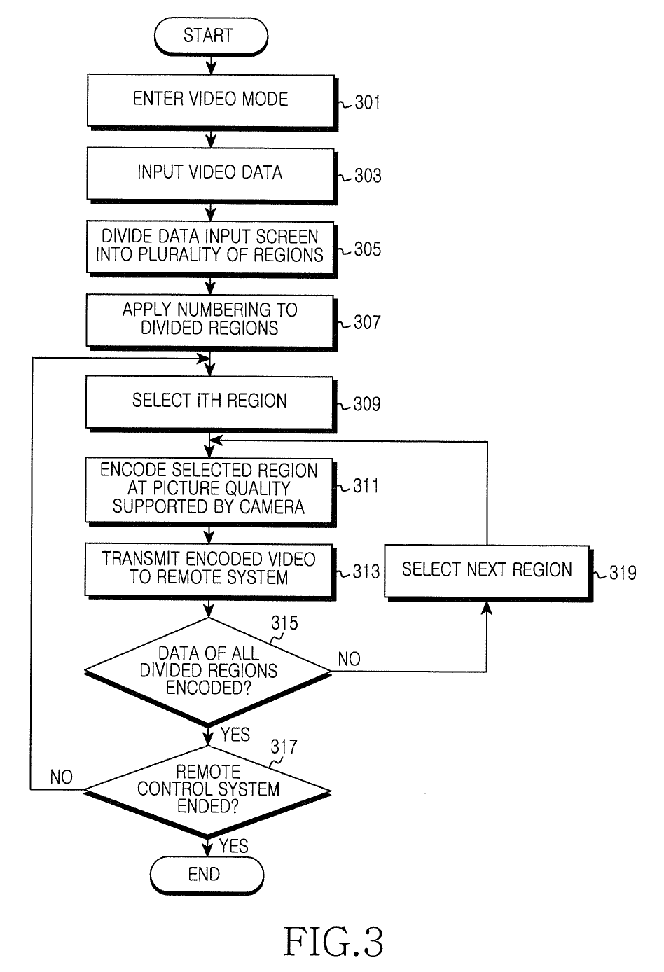

FIG. 3 is a flowchart illustrating a process of transmitting high quality video data in a video device according to the present disclosure.

Referring to FIG. 3, the video device is a video device supporting lower quality data, and can be a mobile communication terminal supporting a camera function, a computer and TV enabling video communication and the like.

The video device supporting the lower quality data enters a video mode and activates a camera module in block 301. After that, the video device proceeds to block 303 and receives an input of video data.

After that, the video device proceeds to block 305 and divides a data input screen into a plurality of regions and then, proceeds to block 307 and applies numbering or image coordinates to the divided regions.

Here, the video device can encode data corresponding to the divided regions at a maximum resolution supported by the video device. The numbering or image coordinates can represent position information of corresponding regions. Thus, an apparatus receiving video data can determine an output position of decoded data by the numbering or image coordinates representing the position information.

After that, the video device proceeds to block 309 and selects an i^{th} region and then, proceeds to block 311 and encodes the selected region at a maximum resolution supported by the video device.

A general video device encodes the whole data input through its own camera, while a video device according to the present disclosure divides an input screen into a plurality of regions and encodes data of the divided regions at a maximum resolution.

Next, the video device proceeds to block 313 and transmits the data (i.e., the video data), which is encoded in a unit of partial region, to a remote system that is a receive apparatus.

After that, the video device proceeds to block 315 and determines if it has performed a data encoding process for all the divided regions.

If it is determined in block 315 that the video device has not performed the data encoding process for all the divided regions, the video device proceeds to block 319 and selects a next region and then, performs the process of block 311.

In contrast, if it is determined in block 315 that the video device has performed the data encoding process for all the divided regions, the video device proceeds to block 317 and determines if a remote control system for determination of real-time video data is terminated.

If it is determined in block 317 that the remote control system is not terminated, the video device returns to block 309 and provides a real-time video to the remote system.

In contrast, if it is determined in block 317 that the remote control system is ended, the video device terminates the algorithm.

In embodiments where a general video device encoding the whole input data as above transmits video data through an IP based service, a receive apparatus cannot receive high quality data at a low resolution (e.g., a QCIF). But, although the receive apparatus supports the low resolution, a video device according to the present disclosure transmits data, which is encoded at a maximum resolution partially supported by the video device, to a remote system, and the remote system receives, decodes, and outputs the encoded data, thereby being capable of determining a high resolution of video data.

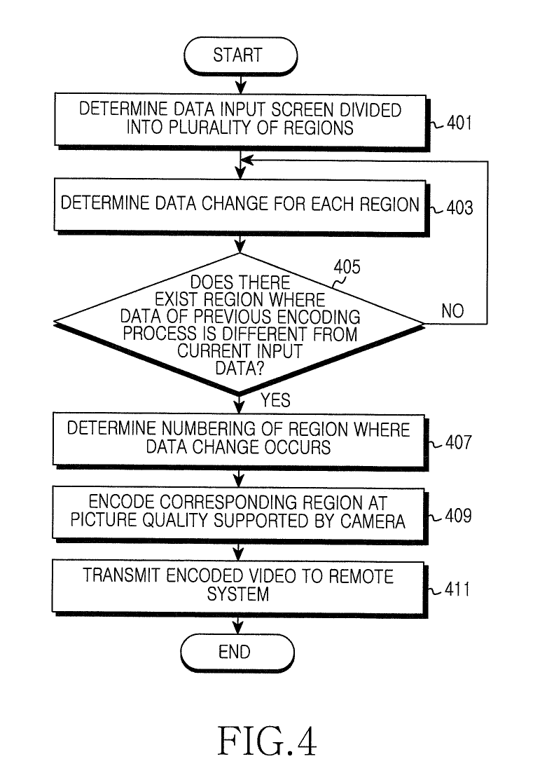

FIG. 4 is a flowchart illustrating a process of providing data on a specific portion in a video device according to an embodiment of the present disclosure.

Referring to FIG. 4, in block 401, the video device determines a data input screen divided into a plurality of regions and then, proceeds to block 403 and determines data change for each of the divided regions. Here, the video device is for comparing previous video data and current video data to determine a change difference and is for sensing a motion occurring in a range capable of being captured by a camera module of the video device.

Next, the video device proceeds to block 405 and determines if there is a region in which data of a previous encoding process is different from current input data, thereby determining if there exists a region where data change occurs.

If it is determined in block 405 that there does not exist a region where the data change occurs, the video device again performs the process of block 403 or performs the process of block 309 of FIG. 3 and provides video data to the remote system.

In contrast, if it is determined in block 405 that there exists a region where the data change occurs, the video device proceeds to block 407 and determines numbering or image coordinates of the region where the data change occurs and then, proceeds to block 409 and performs a process of encoding the region at a picture quality supported by a camera.

After that, the video device proceeds to block 411 and transmits the encoded video to the remote system and then, terminates the algorithm.

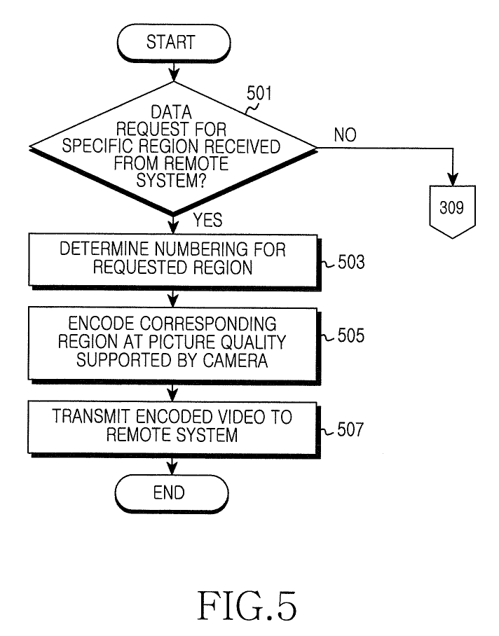

FIG. 5 is a flowchart illustrating a process of providing data on a specific portion in a video device according to another embodiment of the present disclosure.

Referring to FIG. 5, in block 501, the video device determines if it receives a data request for a specific region from a remote system.

If it is determined in block 501 that the video device does not receive the data request for the specific region, the video device performs the process of block 309 of FIG. 3 and provides video data to the remote system.

In contrast, if it is determined in block 501 that the video device receives the data request for the specific region, the video device proceeds to block 503 and determines numbering or image coordinates of the requested region and then, proceeds to block 505 and determines the region of the determined numbering or image coordinates and encodes data on the determined region at a picture quality supported by a camera.

After that, the video device proceeds to block 507 and transmits the encoded (video) data to the remote system.

Next, the video device terminates the algorithm.

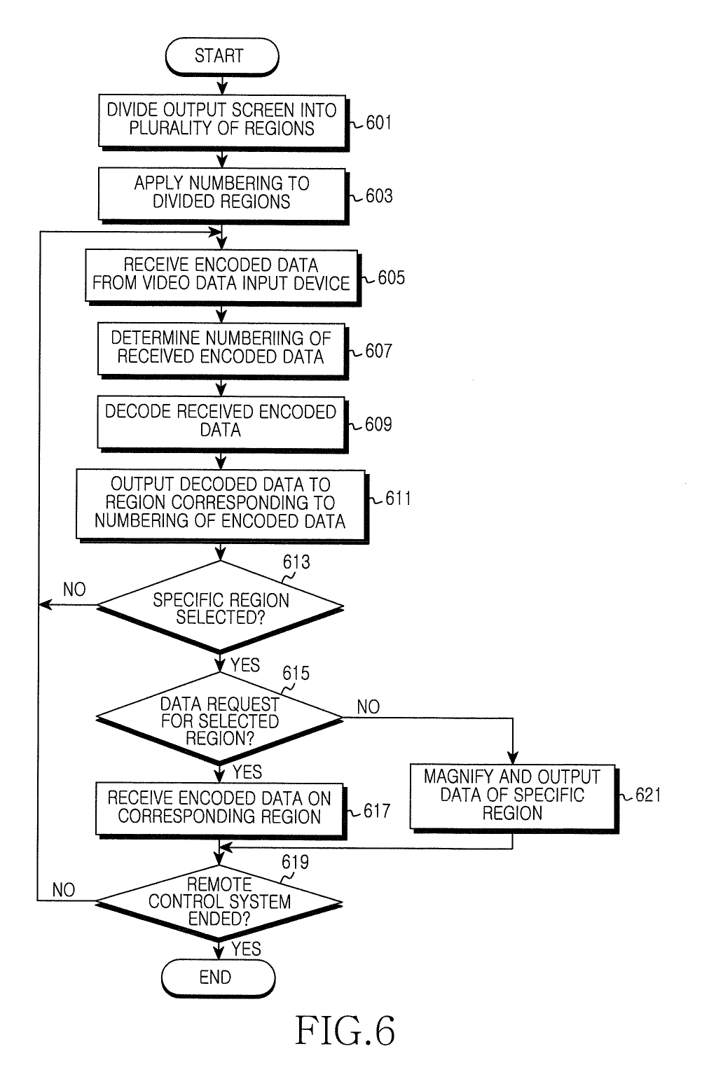

FIG. 6 is a flowchart illustrating a process of receiving video data in a remote system according to an embodiment of the present disclosure.

Referring to FIG. 6, in block 601, the remote system divides an output screen into a plurality of regions and then, proceeds to block 603 and applies numbering or image coordinates to the divided regions. A video device divides an output screen in order to select a region for decoding as described earlier, but the remote system divides the output screen in order to select an output position of decoded video data.

Next, the remote system proceeds to block 605 and receives encoded data from a video device having received an input of video data, and proceeds to block 607 and determines numbering or image coordinates of the received encoded data, thereby determining an output region of the received data.

After that, the remote system proceeds to block 609 and decodes the received encoded data and then, proceeds to block 611 and outputs the decoded data to a region corresponding to the numbering or image coordinates determined in block 607.

Next, the remote system proceeds to block 613 and determines if it receives a user's selection for a specific region. Here, the selection for the specific region can be a magnification output request for the selected region or a data transmission request for the selected region.

If it is determined in block 613 that the remote system does not sense the selection for the specific region, the remote system again performs the process of block 605.

In contrast, if it is determined in block 613 that the remote system senses the selection for the specific region, the remote system proceeds to block 615 and determines if the user's selection sensed in block 613 is the data transmission request for the specific region.

If it is determined in block 615 that the user's selection is the data magnification output request for the specific region, the remote system proceeds to block 621 and magnifies and outputs data of a region selected by a user.

In contrast, if it is determined in block 615 that the user's selection is the data transmission request for the specific region, the remote system proceeds to block 617 and, after sending the video device a request for data of the region selected by the user, receives encoded data on a corresponding region. The remote system transmits numbering or image coordinates for a corresponding region to the video device to make a request for data for a specific region. The numbering or image coordinates include coordinates for a divided region (i.e., coordinates of X and Y axes of points forming the region). The remote system can transmit a coordinate value representing a region selected by a user instead of numbering, to the video device.

After that, the remote system proceeds to block 619 and determines if a remote control system is ended.

If it is determined in block 619 that the remote control system is not ended, the remote system returns to block 605 and again performs a process of decoding data provided from the video device and outputting the decoded data.

In contrast, if it is determined in block 619 that the remote control system is ended, the remote system terminates the algorithm.

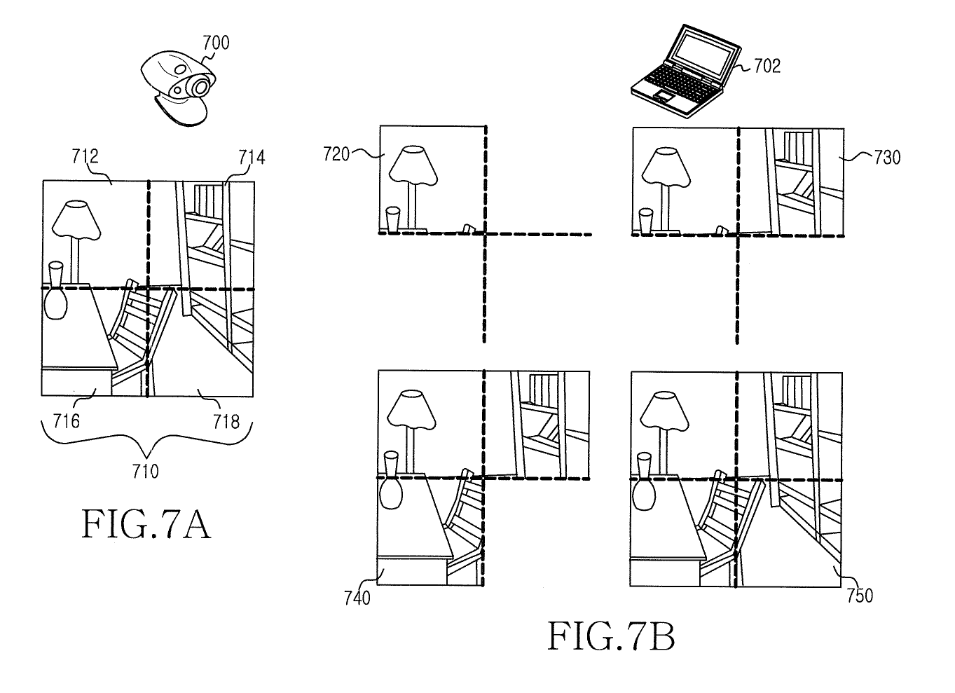

FIGS. 7A and 7B are diagrams illustrating an operation process of a remote control system according to an embodiment of the present disclosure.

FIG. 7A is a diagram illustrating a process of processing high quality video data in a video device according to an embodiment of the present disclosure.

Referring to FIG. 7A, the video device 700, which is a video device supporting lower quality data, can be a mobile communication terminal supporting a camera function, a computer and TV enabling video communication and the like.

The video device 700 supporting the lower quality data activates a camera module and then, receives an input of data corresponding to the direction of the camera module.

In embodiments where the video device 700 receives an input of data on the inside of a room in which there exist a table and a bookshelf, the video device 700 divides an input data input screen 710 into a plurality of regions 712, 714, 716, and 718.

The video device 700 can grant numbering for the divided regions or store coordinates for the divided regions. The numbering or coordinates are for matching data of the divided regions and data output positions of a remote system.

A conventional video device encodes the whole input video data at a resolution supported by video device and transmits the encoded data to the remote system, but a video device according to the present disclosure encodes data of the divided regions and transmits the encoded data to the remote system.

In embodiments where the video device divides the video data into four regions, the video device performs encoding in order of the numbering granted to the divided regions. In embodiments where the video device is to perform the above encoding process, the video device will perform the encoding process of totally four times for the whole screen.

FIG. 7B is a diagram illustrating a process of processing high quality video data in a remote system according to an embodiment of the present disclosure.

Referring to FIG. 7B, the remote system 702 represents a device for decoding and outputting video data provided from the video device 700.

Generally, a conventional remote system receives data encoding the whole picture from the video device 700 and then, decodes and outputs the encoded data.

In contrast, the remote system 702 according to the present disclosure divides one screen into a plurality of regions and receives data encoding, as one screen, each divided region and then, decodes and outputs each data.

The remote system 702 can determine numbering or image coordinates of the received data, thereby determining output positions of the received data.

When the remote system 702 receives data of a top left region 720 of an output screen among input data of the video device 700 as illustrated, the remote system 702 processes to determine numbering or image coordinates of the received data to determine that the received data is data corresponding to the top left region, decode the received data, and output the decoded data at the top left region of the output screen.

When the remote system 702 receives data of a top right region 730 among the input data of the video device 700, the remote system 702 processes to determine numbering or image coordinates of the received data to determine that the received data is data corresponding to the top right region, decode the received data, and output the decoded data at the top right region of the output screen.

The remote system 702 decodes and outputs data of a bottom left region 740 and a bottom right region 750 according to the above method to output data of the whole screen. The data of the divided regions 720-750 correspond to a maximum resolution supported by the video device 700. The remote system 702 can determine higher quality video data than in a conventional method of decoding the whole screen at a time.

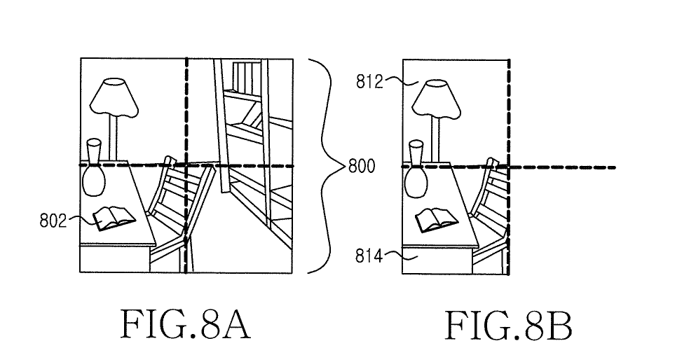

FIGS. 8A and 8B are diagrams illustrating a process of transmitting high quality video data of a specific region in a video device according to an embodiment of the present disclosure.

Referring to FIG. 8A, after dividing a data input screen into a plurality of regions as described earlier, the video device encodes data of the divided regions and transmits the encoded data to a remote system according to the present disclosure.

Some video devices encode the data of the divided regions successively in predefined order and provide the encoded data to the remote system. In contrast, the video device according to the present disclosure can encode data of a specific region in order of priority using a change (e.g., a motion change) of the divided region.

For example, the video device is able to compare data 800 of each divided region with data of a previous encoding block to sense a change of the divided region. In a situation where the video device senses (802) a change that a book is placed at a bottom left region after encoding and providing data of a top left region to a remote system as illustrated in FIG. 8A, although it is scheduled to encode a top right region, the video device encodes data of the bottom left region at which the change is sensed and transmits the encoded data to the remote system.

Thus, as illustrated in FIG. 8B, the remote system decodes and outputs (814) the data of the bottom left region although the remote system decodes and output data of a top right region after decoding and outputting (812) the data of the top left region.

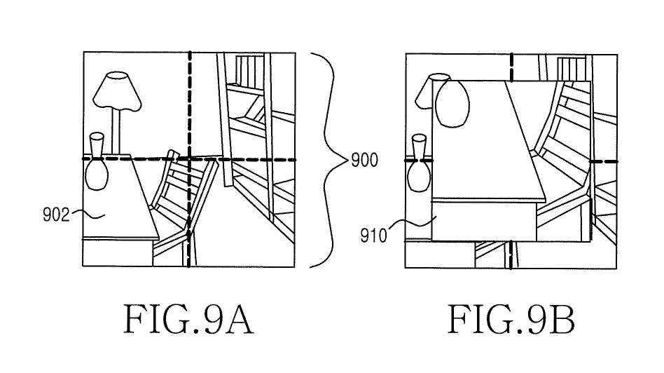

FIGS. 9A and 9B are diagrams illustrating a process of magnifying and outputting data of a specific region in a remote system according to an embodiment of the present disclosure.

Referring to FIG. 9A, the remote system decodes and outputs (900) data received from a video device.

After that, when the remote system senses a magnification output request for a specific region from a user, the remote system determines a requested region and magnifies and outputs the determined region.

For instance, when the remote system senses (902) a magnification output request for a region corresponding to a bottom left region from the user, the remote system magnifies and outputs (910) data of the region as illustrated in FIG. 9B. The region magnified and outputted by the remote system has a resolution corresponding to an encoding resolution of the video device.

As described above, exemplary embodiments of the present disclosure are for transmitting high quality video data in a video device supporting lower quality resolution and, by partially compressing and providing input data, the embodiments of the present disclosure can provide high quality video communication service and enable even magnification and output for a specific region. Thus, the embodiments of the present disclosure can consolidate the video device as a home monitoring system.

While the disclosure has been shown and described with reference to certain preferred embodiments thereof, it will be understood by those skilled in the art that various changes in form and details may be made therein without departing from the spirit and scope of the disclosure as defined by the appended claims.

What is claimed is:

1. An apparatus for transmitting data in a video device, the apparatus comprising:
a controller configured to control an encoding unit, divide a video data input screen into a plurality of regions, and transmit encoded data on the divided videos to a remote system; and
the encoding unit configured to encode the divided videos into video data.

2. The apparatus of claim 1, wherein the encoding unit encodes the video at a maximum resolution supported by the video device.

3. The apparatus of claim 1, wherein the encoding unit comprises position information on regions to which the divided videos belong among the input screen and encodes the videos.

4. The apparatus of claim 1, wherein the encoding unit encodes aiming at a video whose motion change occurs among the divided videos.

5. The apparatus of claim 1, wherein, when the encoding unit senses a video data request for a specific region from the remote system, the encoding unit determines position information comprised in the request and encodes a video corresponding to the determined position into video data.

6. The apparatus of claim 1, wherein the remote system receiving the encoded video data comprises:
a decoding unit configured to decode the received video data; and
a controller configured to output the decoded video data.

7. The apparatus of claim 6, wherein the controller outputs the decoded video data to a position corresponding to position information comprised in the encoded data.

8. The apparatus of claim 6, wherein, after outputting the decoded video data, the controller magnifies and outputs video data corresponding to a user's selection.

9. The apparatus of claim 6, wherein, after outputting the decoded video data, the controller sends to the video device a video data request for a region corresponding to a user's selection,
the request comprising position information corresponding to the user's selection.

10. A method for transmitting data in a video device, the method comprising:
dividing a video data input screen into a plurality of regions;
encoding the divided videos into video data; and
transmitting the encoded video data to a remote system.

11. The method of claim 10, wherein encoding the divided videos into the video data encodes the video at a maximum resolution supported by the video device.

12. The method of claim 10, wherein encoding the divided videos into the video data comprises position information on regions to which the divided videos belong among the input screen.

13. The method of claim 10, wherein encoding the divided videos into the video data encodes aiming at a video whose motion change occurs among the divided videos.

14. The method of claim 10, further comprising, when sensing a video data request for a specific region from the remote system:
determining position information comprised in the request; and
encoding a video corresponding to the determined position into video data.

15. The method of claim 10, further comprising, in the remote system, after receiving the encoded video data:
decoding the received video data; and
outputting the decoded video data.

16. The method of claim 15, wherein the decoded video data is output to a position corresponding to position information comprised in the encoded data.

17. The method of claim 15, further comprising, after outputting the decoded video data, magnifying and outputting video data corresponding to a user's selection.

18. The method of claim 15, further comprising, after outputting the decoded video data,
sending the video device a video data request for a region corresponding to a user's selection,
the request comprising position information corresponding to the user's selection.

19. The method of claim 10, wherein the plurality of regions comprises four quadrants of the screen.

20. The apparatus of claim 1, wherein the plurality of regions comprises four quadrants of the screen.
